(19) United States
(12) Patent Application Publication
(10) Pub. No.: US 2020/0096805 A1
(43) Pub. Date: Mar. 26, 2020

(54) CURVED OPTICAL MODULATOR

(71) Applicant: FLEXENABLE LIMITED, Cambridge (GB)

(72) Inventor: William REEVES, Cambridge (GB)

(73) Assignee: FLEXENABLE LIMITED, Cambridge (GB)

(21) Appl. No.: 16/575,989

(22) Filed: Sep. 19, 2019

(30) Foreign Application Priority Data
Sep. 20, 2018 (GB) 1815352.8

(51) Int. Cl. G02F 1/1333; G02F 1/1343

(52) U.S. Cl. CPC G02F 1/133305; G02F 1/133528; G02F 2202/02; G02F 1/134336

(57) ABSTRACT

A method of forming a curved optical modulator component for use with a backlight, wherein the optical modulator component comprises at least a control component including a support film supporting a stack of layers defining an array of pixel electrodes independently addressable via conductors outside the array of pixel electrodes; and wherein the method comprises: preparing at least said control component in a substantially planar configuration; forcibly flexing the control component into a stressed configuration about a curved surface of a first curved component and bonding the control component in the stressed configuration to the curved component on one side of the control component; and bonding a second curved component to at least the control component on an opposite side of the control component.

Some display devices comprise a backlight in combination with an optical modulator to modulate the light from the backlight.

The inventor for the present application has conducted research into the production of curved devices of this kind.

There is hereby provided a method of forming a curved optical modulator component for use with a backlight, wherein the optical modulator component comprises at least a control component including a support film supporting a stack of layers defining an array of pixel electrodes independently addressable via conductors outside the array of pixel electrodes; and wherein the method comprises: preparing at least said control component in a substantially planar configuration; forcibly flexing the control component into a stressed configuration about a curved surface of a first curved component and bonding the control component in the stressed configuration to the curved component on one side of the control component; and bonding a second curved component to at least the control component on an opposite side of the control component.

According to one embodiment, the method comprises: preparing a liquid crystal cell component in substantially planar configuration, wherein the liquid crystal cell component comprises liquid crystal material contained between the control component and a counter component; forcibly flexing the liquid crystal cell component into a stressed configuration about a curved surface of a first curved component, and bonding the liquid crystal cell component in the stressed configuration to the first curved component on one side of the liquid crystal cell component; and bonding the second curved component to at least the liquid crystal cell component on the opposite side of at least the liquid crystal cell component.

According to one embodiment, the method comprises: preparing polarisation filters in a substantially planar configurations, and bonding polarisation filters in planar configurations to both sides of the liquid crystal cell component in a planar configuration before bonding the liquid crystal cell to the first curved component via one of the polarisation filters.

According to one embodiment, the method comprises: preparing a first plastics film, polarisation filter component in a substantially planar configuration, forcibly flexing the first polarisation filter component into a stressed configuration about a curved surface of the first curved component, and bonding the polarisation filter component in the stressed configuration to the first curved component, before bonding the liquid crystal cell component to the curved component via the first polarisation filter; preparing a second plastics film, polarisation filter component in a substantially planar configuration, forcibly flexing the first polarisation filter component into a stressed configuration about a curved surface of the liquid crystal cell component in situ on the first curved component, and bonding the second polarisation filter component in the stressed configuration to the first curved support component via the liquid crystal cell component and the first polarisation component; and bonding the second curved component to the second polarisation component in situ bonded to the first curved component via the liquid crystal cell component and first polarisation filter component.

According to one embodiment, the first and second curved components have substantially the same thermal expansion properties.

According to one embodiment, the first and second curved components comprise the same material and have substantially the same thickness.

According to one embodiment, the method comprises: combining the curved optical modulator component together with a curved backlight component.

An embodiment of the invention is described in detail hereunder, by way of example only, with reference to the accompanying drawings, in which:

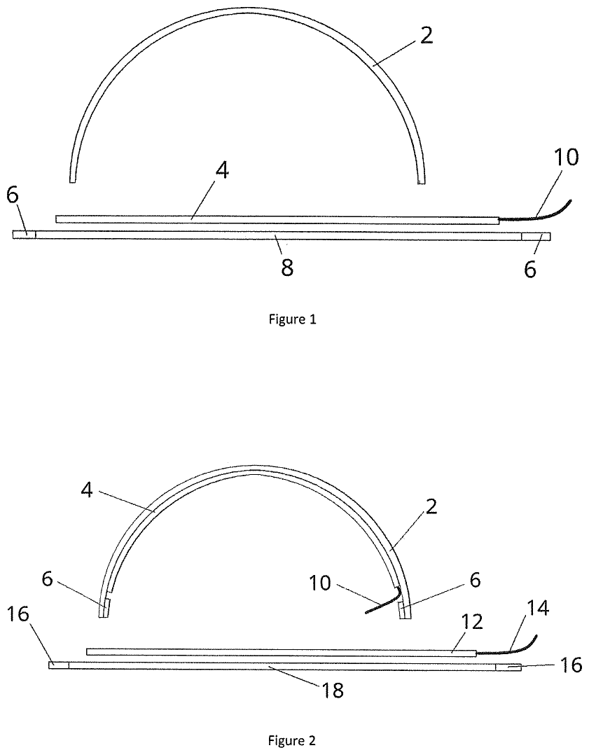

FIG. 1 illustrates a first step in an example of a technique according to an embodiment of the invention;

FIG. 2 illustrates a second step in an example of a technique according to an embodiment of the invention;

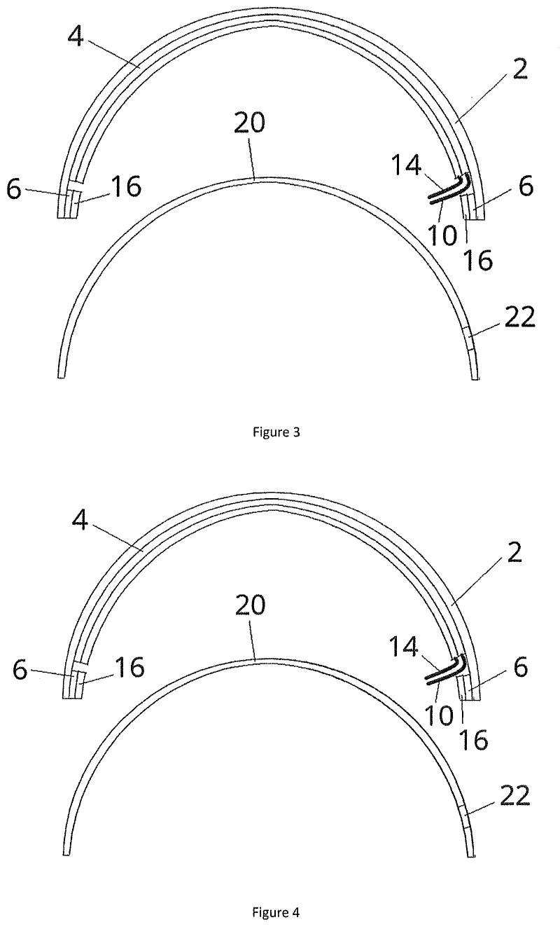

FIG. 3 illustrates a first step in an example of a technique according to an embodiment of the invention;

FIG. 4 illustrates a first step in an example of a technique according to an embodiment of the invention;

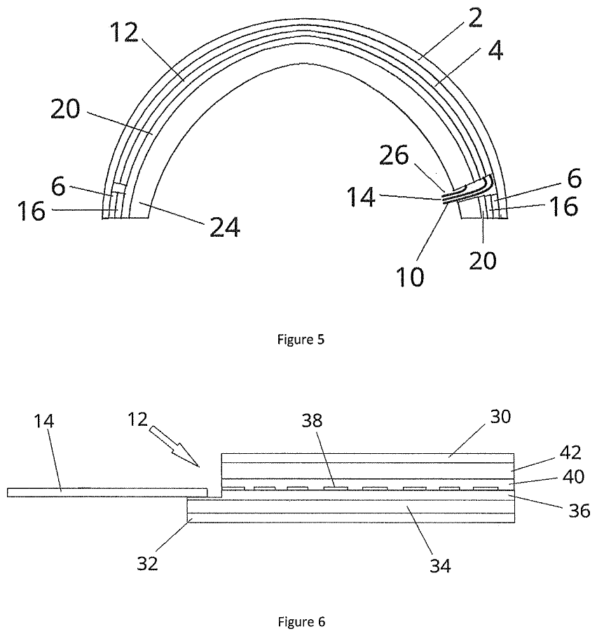

FIG. 5 illustrates a first step in an example of a technique according to an embodiment of the invention; and

FIG. 6 illustrates an example of an optical modulator component for the technique shown in FIGS. 1 to 5.

An embodiment of the invention is described below for the example of the production of an organic liquid crystal display (OLCD) device, which comprises an organic transistor device (such as an organic thin film transistor (OTFT) device) for the control component. OTFTs comprise an organic semiconductor (such as e.g. an organic polymer or small-molecule semiconductor) for the semiconductor channels. However, the same technique is also applicable to the production of e.g. other kinds of liquid crystal display devices, and display devices other than liquid crystal display devices.

This example starts with the preparation of a curved front cover component 2. This curved component 2 is transparent in at least the visible range of wavelengths in at least the display output area of the device, which as mentioned below may be defined by the area of an array of pixel electrodes of a control component of the device. In one example, the curved support component 2 comprises acrylic plastic (PMMA) and is formed by a thermoforming technique involving heating a planar sheet of the plastic material to a forming temperature, shaping the planar sheet into the desired curved configuration, and cooling the sheet in this new configuration. As the sheet cools, the sheet hardens and permanently retains the new curved configuration (the new curved configuration becomes the new resting configuration for the sheet). In another example, the curved front cover component 2 is formed by bonding one surface area of a first plastics film sub-component (e.g. hard-coated, planar acrylic sheet) to a smaller surface area of a second plastics film sub-component (e.g. another hard-coated planar acrylic sheet of the same thickness), by e.g. flexing the two plastics film sub-components into stressed curved configurations using a rigid lamination aid, bonding the two plastics film sub-components to each other in the stressed configurations. This alternative technique yet further facilitates the production of curved front cover component 2 with a hard coating, without needing to coat a curved surface.

The curved front cover component 2 is resiliently flexible; when the curved front cover component 2 is forcibly flexed out of its curved resting configuration, internal stresses are generated within the front cover component 2 which act to return the front cover component 2 back to its curved resting configuration.

A plastics film component 4 having touch sensor functionality is prepared in a substantially planar configuration. A plastics film component refers to a component comprising one or more plastics films. The touch sensor component 4 is resiliently flexible; when the touch sensor component is forcibly flexed out of this planar configuration, internal stresses are generated within the touch sensor component 4 which act to return the touch sensor component back to the planar configuration. The touch sensor component has one or more electrical connectors 10 extending from an edge of the touch sensor component.

The touch sensor component 4 is forcibly flexed into a stressed configuration about a curved surface of the front cover component 2 (which may involve using a rigid former/lamination aid to temporarily support the front cover component 2), and bonded in the stressed configuration to the curved front cover component 2. In this example, the bonding is achieved by a dry bonding lamination technique. A film of adhesive (not shown) is applied to the touch sensor component 4, and successive portions of the touch sensor component 4 are forcibly pressed against the curved front cover component 2 via the film of adhesive from one end of the touch sensor component 4 to an opposite end, such that the whole area of the touch sensor component 4 is bonded to the curved front cover component 2 without any air between the touch sensor component 4 and the curved front cover component 2. The area of the touch sensor component 4 is smaller than the area of the curved front cover component 2. A gasket component 6 having substantially the same thickness as the touch sensor component 4 is also bonded to the curved front cover component 2 so as to closely frame the touch sensor component 4 on all sides, while leaving a space to accommodate the electrical connector(s) 10. The touch sensor component 4 fits within a window 8 defined by the gasket component 6. The gasket component 6 may, for example, comprise adhesive foam sheet (e.g. acrylic foam sheet).

A second plastics film component 12 having optical modulator functionality is also prepared in a substantially planar configuration. The optical modulator component 12 is also resiliently flexible; when the optical modulator component 12 is forcibly flexed out of this planar configuration, internal stresses are generated within the optical modulator component 12 which act to return the optical modulator component back to the planar configuration. The optical modulator component has one or more electrical connectors 14 extending from an edge of the optical modulator component 12.

In this example, the optical modulator component 12 comprises plastics film polarisation filter components 30, 32 bonded in substantially planar configurations to both sides of another substantially planar plastics film component defining a liquid crystal (LC) cell including LC material contained between a plastics film control component and a plastics film counter component 42 defining a colour filter array (CFA). The optical modulator component 12 may also comprise other components such as one or more encapsulation films etc.; and/or one or more other substantially planar components such as one or more encapsulation films etc. may be bonded in a stressed configuration to the rear surface of the front cover component 2 before and/or after bonding the optical modulator component 12 to the front cover component 2.

With further reference to FIG. 6, the plastics film control component comprises a stack 36 of conductor, semiconductor and insulator layers formed in situ on a plastics support film 34. The stack 36 defines an array of pixel electrodes 38 (whose total area defines the display output area of the display device), and electrical circuitry for independently controlling each pixel electrode 36 via conductors outside the array of pixel electrodes 36. The stack 36 may, for example, define an active matrix array of thin-film transistors, including: an array of gate conductors each providing the gate electrode for a respective row of TFTs, and extending to outside the array of pixel electrodes; and an array of source conductors each providing the source electrode for a respective column of TFTs, and extending to outside the array of pixel electrodes. Each pixel electrode is associated with a respective TFT, and each TFT is associated with a unique combination of gate and source conductors, whereby each pixel electrode can be addressed independently of all other pixel electrodes.

A substantially uniform thickness of liquid crystal material 40 is contained between the array of pixel electrodes 38 and the plastics film counter component 42.

In this example, the electrical connector 14 comprises a chip-on-flex (COF) unit is bonded to a portion of the support film 34 outside the array of pixel electrodes 38 to create a conductive connection between (i) an array of conductors (e.g. source and gate addressing conductors) defined by the stack in a region outside the array of pixel electrodes and (ii) a corresponding array of conductors of the COF unit, which are connected to the terminals of one or more driver chips forming part of the COF unit.

The optical modulator component 12 is forcibly flexed into a stressed configuration about a curved rear surface of the bonded assembly comprising the front cover component 2 and the touch sensor component, and bonded in the stressed configuration to the bonded assembly. In this example, this bonding is achieved by a dry bonding lamination technique. A film of adhesive (not shown) is applied to the optical modulator component 12, and successive portions of the optical modulator component 12 are forcibly pressed against the touch sensor component in situ on the curved support component 2 via the film of adhesive from one end of the optical modulator component 4 to an opposite end, such that the whole area of the optical modulator component 12 is bonded to the touch sensor component 4 without any air between the optical modulator component 12 and the touch sensor component 4. The area of the optical modulator component 12 is also smaller than the area of the curved support component, and has substantially the same X-Y dimensions as the touch sensor component 4. A second gasket component 16 having substantially the same thickness as the optical modulator component 12 is also bonded to the curved support component 2 via the first gasket component 6 so as to closely frame the optical modulator component on all sides, while leaving a space to accommodate the electrical connector(s) 10, 14. The optical modulator component 12 fits within a window 18 defined by the gasket component 16.

According to one variation of the example described above, the plastics film polarisation filter components 30, 32 and plastics film liquid cell component are bonded in sequence to the curved support component 2 via the touch sensor component 4. In detail, one of the polarisation filter components 30, 32 is first forcibly flexed into a stressed configuration about a curved surface of the bonded assembly comprising the front cover component 2 and the touch sensor component 4, and bonded in the stressed configuration to the rear surface of the bonded assembly (e.g. using a dry bonding lamination technique); the plastics film liquid cell component is then forcibly flexed into a stressed configuration about the curved rear surface of the resulting bonded assembly (comprising the front cover component 2, touch sensor component 4 and first polarisation filter component), and bonded in the stressed configuration thereto (e.g. using a dry bonding lamination technique); and then the other of the two polarisation filter components 30, 32 is forcibly flexed into a stressed configuration about the curved rear surface of the resulting bonded assembly (comprising the front cover component 2, touch sensor component 4, first polarisation filter component and liquid crystal cell component), and bonded in the stressed configuration thereto (e.g. using a dry bonding lamination technique).

Next, a curved rear component 20 is bonded (e.g. using a dry bonding lamination technique) to the optical modulator component 12 in situ on the curved front cover component. This curved rear component 20 is also transparent in at least the visible range of wavelengths in at least the display output area of the device, which as mentioned below may be defined by the area of an array of pixel electrodes of a control component described below. In this example, the curved rear component may also comprise acrylic plastic (PMMA) and may be formed by a thermoforming technique involving heating a planar sheet of the plastic material to a forming temperature, shaping the planar sheet into the desired curved configuration, and cooling the sheet in this new configuration. As the sheet cools, the sheet hardens and permanently retains the new curved configuration (the new curved configuration becomes the new resting configuration for the sheet). Alternatively, the curved rear component 2 is formed by bonding one surface area of a first plastics film sub-component to a smaller surface area of a second plastics film sub-component, by e.g. flexing the two plastics film sub-components into stressed curved configurations using a rigid lamination aid, and bonding the two plastics film sub-components to each other in the stressed configurations. This alternative technique yet further facilitates e.g. the production of a curved rear component 2 with a surface-treated front surface that provides diffuser functionality.

The curved rear component 20 is resiliently flexible; when the curved component 20 is forcibly flexed out of its curved resting configuration, internal stresses are generated within the curved rear component 20 which act to return the curved rear component 20 back to its curved resting configuration. In this example, the curved rear component 20 provides surface diffuser functionality; the curved rear component 20 functions to smoothen out any variations across the display output area in the intensity of light from the backlight (discussed below). For example, the bulk material of the curved rear component may be a light-scattering material that provides the diffuser functionality, or the curved rear component 2 has a surface-treated front surface that provides the optical diffuser functionality.

The curved diffuser component 20 defines a through hole 22 through which the electrical connectors 10, 14 extend to the rear of the diffuser component 20.

In this example, the two curved components 2, 20 have substantially the same thermal expansion properties; the two curved components 2, 20 are made from the same material and have substantially the same thickness. This balancing of the thermal expansion properties can be particularly advantageous when using materials (such as acrylic) with relatively high thermal expansion coefficients for the two curved components, in order to better prevent changes in the conditions in which the product device is used causing bowing of the device.

In this example, at least the curved rear component 20 has a higher bending stiffness than the plastics film component(s) between the two curved components 2, 20; and is the primary contributor to the combined bending stiffness of the whole bonded assembly. Having a curved rear component with a relatively high bending stiffness allows the curved front cover component 2 to be made thinner than it would otherwise need to be to achieve the same combined bending stiffness for the whole assembly. Reducing the thickness of the curved front cover component 2 can be advantageous for: easing viewing angle restrictions; improving the performance of the touch sensor component 4; and facilitating the use of surface finishing treatments for the curved front cover component, such as a matte-finish treatment to reduce the specular reflection of external light incident on the curved front cover component 2.

The adhesive bonds between each pair of adjacent components are sufficiently strong to hold the first and second curved support components 2, 20 together (via the touch sensor component 4 and optical modulator component 12) against the tendency of the touch sensor and optical modulator components 4, 12 to relax back to their substantially planar resting configurations.

In one variation of the above-described technique, the optical modulator component 12 and touch sensor component 4 are bonded in sequence to the rear curved component (diffuser component) 20, and the curved front cover component 2 is thereafter bonded to the curved front surface of the resulting assembly.

In one example as shown in FIG. 4, a backlight is provided by a backlight component 24 integrated together with the assembly comprising the curved front cover component 2, touch sensor component 4, optical modulator component 12 and curved rear component 20. In this example, the backlight component 24 also defines a through hole 28 through which the electrical connectors 10, 14 from the touch sensor component 4 and the optical modulator component 12 extend to the rear of the backlight together with the electrical connector(s) 26 for the backlight component 24 itself. The backlight component 24 may be of a direct-lit type in which light sources are located within the output area of the display, or a side-lit type in which light sources are located outside the output area of the display, and a waveguide guides the light from these light sources across the output of the display while redirecting (by e.g. scattering) some of the light in the direction of the optical modulator component 24. In another example, the backlight is provided by a free-standing component, such as a lighting component which has a primary function other than providing light for the display device.

In the example described above, each component extends over the whole area of the front cover component 2, such that the device has substantially the same thickness across the whole area of the front cover component. In one variation, one or more of the components may not extend across the whole area of the front cover component 2 (i.e. one or more of the components may have a lateral edge outside the output area but inwards of the lateral edge of the front cover component 2). In other words, a peripheral portion of the area of the front cover component 2 may not be occupied by one or more of the other components, whereby the display device has a smaller thickness in this peripheral portion relative to the thickness in the output area. In one example, the absence of one or more components in a peripheral region adjacent to the electrical connectors 10, 14, 26 can facilitate a smaller radius of curvature for the bending back of these electrical connectors 10, 14, 26 to behind the output area.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A method of forming a curved optical modulator component for use with a backlight, wherein the optical modulator component comprises at least a control component including a support film supporting a stack of layers defining an array of pixel electrodes independently addressable via conductors outside the array of pixel electrodes; and wherein the method comprises: preparing at least said control component in a substantially planar configuration; forcibly flexing the control component into a stressed configuration about a curved surface of a first curved component and bonding the control component in the stressed configuration to the curved component on one side of the control component; and bonding a second curved component to at least the control component on an opposite side of the control component.

2. The method according to claim 1, comprising: preparing a liquid crystal cell component in substantially planar configuration, wherein the liquid crystal cell component comprises liquid crystal material contained between the control component and a counter component; forcibly flexing the liquid crystal cell component into a stressed configuration about a curved surface of a first curved component, and bonding the liquid crystal cell component in the stressed configuration to the first curved component on one side of the liquid crystal cell component; and bonding the second curved component to at least the liquid crystal cell component on the opposite side of at least the liquid crystal cell component.

3. The method according to claim 2, comprising: preparing polarisation filters in a substantially planar configurations, and bonding polarisation filters in planar configurations to both sides of the liquid crystal cell component in a planar configuration before bonding the liquid crystal cell to the first curved component via one of the polarisation filters.

4. The method according to claim 2, further comprising: preparing a first plastics film, polarisation filter component in a substantially planar configuration, forcibly flexing the first polarisation filter component into a stressed configuration about a curved surface of the first curved component, and bonding the polarisation filter component in the stressed configuration to the first curved component, before bonding the liquid crystal cell component to the curved component via the first polarisation filter; preparing a second plastics film, polarisation filter component in a substantially planar configuration, forcibly flexing the first polarisation filter component into a stressed configuration about a curved surface of the liquid crystal cell component in situ on the first curved component, and bonding the second polarisation filter component in the stressed configuration to the first curved support component via the liquid crystal cell component and the first polarisation component; and bonding the second curved component to the second polarisation component in situ bonded to the first curved component via the liquid crystal cell component and first polarisation filter component.

5. The method according to claim 1, wherein the first and second curved components have substantially the same thermal expansion properties.

6. The method according to claim 5, wherein the first and second curved components comprise the same material and have substantially the same thickness.

7. The method according to claim 1, further comprising: combining the curved optical modulator component together with a curved backlight component.
